(19) United States
(12) Patent Application Publication
(10) Pub. No.: US 2019/0235045 A1
(43) Pub. Date: Aug. 1, 2019

(54) ANTENNA, WIRELESS TRANSMISSION DEVICE, AND POSITION MEASUREMENT SYSTEM

(71) Applicant: PANASONIC INTELLECTUAL PROPERTY MANAGEMENT CO., LTD., Osaka (JP)

(72) Inventors: Takahiro YAMAGUCHI, Osaka (JP); Manabu YAMAGUCHI, Kanagawa (JP); Kenshi HORIHATA, Kanagawa (JP)

(73) Assignee: PANASONIC INTELLECTUAL PROPERTY MANAGEMENT CO., LTD., Osaka (JP)

(21) Appl. No.: 16/339,644

(22) PCT Filed: Jul. 3, 2017
(86) PCT No.: PCT/JP2017/024293

§ 371 Date: Apr. 4, 2019

(30) Foreign Application Priority Data
Oct. 14, 2016 (JP) 2016-202467

(51) Int. Cl. G01S 5/02; H01Q 13/08; H01Q 21/06; H04W 64/00

(52) U.S. Cl. CPC G01S 5/0205; H04W 64/00; H01Q 21/06; H01Q 13/08

(57) ABSTRACT

An accuracy of required position measurement can be ensured and an antenna can be miniaturized.

An antenna which transmits a wireless signal for position measurement includes a board formed of a dielectric material, four radiation conductors formed in a 2×2 array on a first surface of the board, and a ground conductor formed on a second surface of the board, and the board and the ground conductor are formed so as not to protrude to the outside of the four radiation conductors.

### TECHNICAL FIELD

The present disclosure relates to an antenna that transmits a wireless signal for position measurement, a wireless transmission device including the antenna, and a position measurement system.

### BACKGROUND ART

In order to measure a position of a terminal, a satellite positioning system such as a GPS (Global Positioning System) is widely used. In the satellite positioning system, the position of the terminal can be measured as the terminal receives a signal transmitted from a satellite, but at a place where the signal from the satellite does not reach, such as an underground shopping center or a building, the position of the terminal cannot be measured.

Therefore, a technique is known in which, in order to enable a position to be measured at the place where the signal from the satellite does not reach, a plurality of transmitters that transmit wireless signals (beacon signal) for position measurement are installed, and the position of the terminal is measured based on the wireless signal of the transmitter (see PTL 1).

### CITATION LIST

### Patent Literature

PTL 1: Japanese Patent Unexamined Publication No. 2015-190979

### SUMMARY OF THE INVENTION

Thus, in order to ensure an accuracy of position measurement, it is necessary to install a sufficient number of transmitters. Accordingly, it is desirable to reduce a manufacturing cost and an installation cost of the transmitter. For example, in a case where the transmitter is installed on the ceiling, since the transmitter needs to be installed by avoiding various ceiling structures, such as being installed between malls on the ceiling, it is desirable to increase a freedom degree of installation.

In order to satisfy such a demand, the transmitter may be miniaturized. In order to miniaturize the transmitter, it is necessary to downsize an antenna which is the largest component. In the miniaturization of this antenna, in a case of a patch antenna adopted in the technique of related art, it is considered that an interval (distance between patches) between power supply elements (patches) is reduced, but if the interval between the power supply elements is reduced, a gain difference between two reference angles decreases, and thus, there is a problem that a difference in electric wave strength between two points cannot be identified from an electric wave noise and the accuracy of position measurement is reduced.

Therefore, a main object of the present disclosure is to provide an antenna, a wireless transmission device, and a position measurement system that can ensure a required accuracy of position measurement and reduce a size of the antenna.

An antenna according to the present disclosure is an antenna transmitting a wireless signal for position measurement, and includes a board that is formed of a dielectric material, four radiation conductors that are formed in a 2×2 array on a first surface of the board, and a ground conductor that is formed on a second surface of the board, in which the board and the ground conductor are formed so as not to protrude to the outside of the four radiation conductors.

A wireless transmission device according to the present disclosure includes the antenna, a storage that stores identification information of the wireless transmission device, and a signal generator that outputs power for a wireless signal to the antenna for transmitting the wireless signal including the identification information of the wireless transmission device from the antenna.

A position measurement system according to the present disclosure includes the wireless transmission device, a terminal device that receives the wireless signal transmitted from the wireless transmission device, and a server device, in which the terminal device acquires an electric wave strength when receiving the wireless signal and transmits the electric wave strength to the server device, and in which the server device acquires position information of the terminal device based on the electric wave strength that is acquired from the terminal device and transmits the position information to the terminal device.

According to the present disclosure, by setting an interval of a radiation conductor so as to ensure a minimum gain difference allowable for ensuring an accuracy required for a position measurement, the accuracy of the required position measurement can be increased, and by forming a board and a ground conductor so as not to protrude to the outside of the radiation conductor, the antenna can be miniaturized.

### BRIEF DESCRIPTION OF DRAWINGS

FIG. 1 is an overall configuration diagram of a position measurement system according to a first exemplary embodiment.

FIG. 2 is a block diagram illustrating a schematic configuration of transmitter 1.

FIG. 3 is a block diagram illustrating a schematic configuration of terminal 2.

FIG. 4 is a block diagram illustrating a schematic configuration of position management server 3.

FIG. 5A is an explanatory diagram illustrating position electric wave information.

FIG. 5B is an explanatory diagram illustrating electric wave information.

FIG. 6 is a block diagram illustrating a schematic configuration of application server 4.

FIG. 7 is a sequence diagram illustrating an operation sequence of transmitter 1, terminal 2, position management server 3, and application server 4.

FIG. 8 is a perspective view of antenna 14.

FIG. 9 is a front view of antenna 14.

FIG. 10 is a cross-sectional view of antenna 14 taken along line X-X illustrated in FIG. 9.

FIG. 11A is an explanatory diagram illustrating an example of an installation state of transmitter 1.

FIG. 11B is a graph representing a relationship between an angle and a gain in the Z direction.

FIG. 12 is a front view of antenna 61 according to a second exemplary embodiment.

FIG. 13 is a rear view of antenna 61 according to the second exemplary embodiment.

### DESCRIPTION OF EMBODIMENTS

A first disclosure made to solve the above-described problem has a configuration which is an antenna that transmits a wireless signal for position measurement and includes a board that is formed of a dielectric material, four radiation conductors that are formed in a 2×2 array on a first surface of the board, and a ground conductor that is formed on a second surface of the board, in which the board and the ground conductor are formed so as not to protrude to the outside of the four radiation conductors.

According to this, by setting an interval of a radiation conductor so as to ensure a minimum gain difference allowable for ensuring an accuracy required for a position measurement, the accuracy of the required position measurement can be increased, and by forming a board and a ground conductor so as not to protrude to the outside of the radiation conductor, the antenna can be miniaturized.

The second disclosure has a configuration which is an antenna that transmits a wireless signal for position measurement and includes a board that is formed of a dielectric material, four radiation conductors that are formed in a 2×2 array on a first surface of the board, and a ground conductor that is formed on a second surface of the board, in which an attachment portion to which a fixing component for being fixed to a case is attached is formed outside the four radiation conductors on the board.

According to this, by setting an interval of a radiation conductor so as to ensure a minimum gain difference allowable for ensuring an accuracy required for a position measurement, the accuracy of the required position measurement can be increased, and by forming an attachment portion on the outside of the radiation conductor, an antenna can be miniaturized, the antenna can be reliably fixed to a case, and furthermore, it is possible to suppress an influence of the attachment portion on a radiated electric wave.

According to a third disclosure, the board includes a peripheral edge portion including the attachment portion on the outside of the radiation conductor, and the ground conductor is formed in a region of the second surface corresponding to a region where the radiation conductor is formed and a region other than the attachment portion in the peripheral edge portion.

According to this, since an absolute gain is increased by widening the ground, it is possible to improve a communication performance such as communication speed.

According to a fourth disclosure, the peripheral edge portion has a width smaller than or equal to one eighth of an entire width of the board.

According to this, it is possible to miniaturize an antenna.

According to a fifth disclosure, the antenna further includes a power supply conductor that is formed on the first surface and supplies power to the radiation conductor, in which the power supply conductor is formed inside a region where the radiation conductor is formed.

According to this, it is possible to miniaturize an antenna.

A sixth disclosure has a configuration which includes the antenna, a storage that stores identification information of the wireless transmission device, and a signal generator that outputs power for a wireless signal to the antenna for transmitting the wireless signal including the identification information of the wireless transmission device from the antenna.

According to this, it is possible to ensure an accuracy of the required position measurement and to miniaturize a wireless transmission device.

A seventh disclosure has a configuration which includes the wireless transmission device, a terminal device that receives the wireless signal transmitted from the wireless transmission device, and a server device, and in which the terminal device acquires an electric wave strength when receiving the wireless signal and transmits the electric wave strength to the server device, and the server device acquires position information of the terminal device based on the electric wave strength that is acquired from the terminal device and transmits the position information to the terminal device.

According to this, it is possible to perform a highly accurate position measurement while miniaturizing a wireless transmission device.

Hereinafter, exemplary embodiments of the present disclosure will be described with reference to the drawings.

### First Exemplary Embodiment

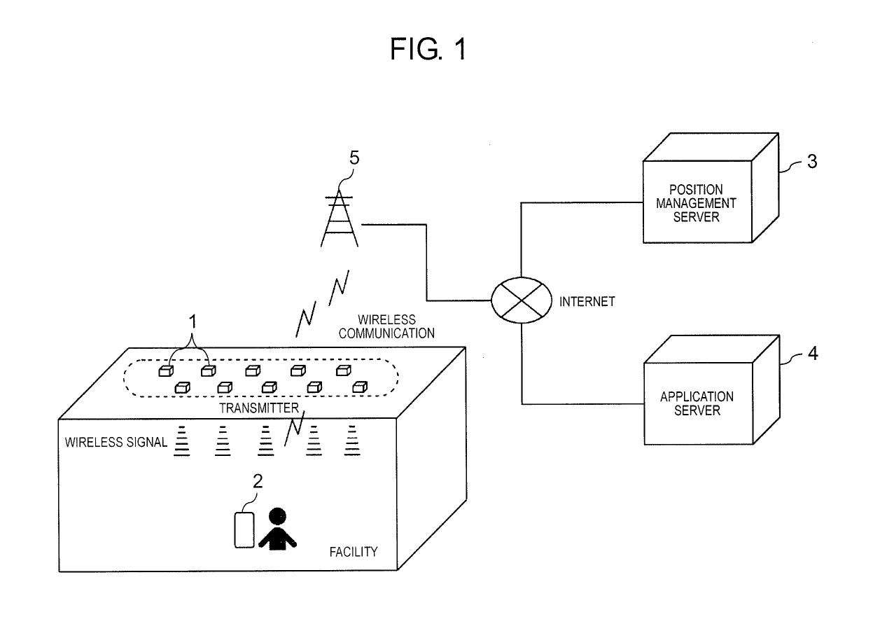

FIG. 1 is an overall configuration diagram of a position measurement system according to a first exemplary embodiment.

The position measurement system enables position measurement at a place where position measurement performed by a satellite positioning system such as GPS cannot be performed, and includes transmitter 1 (wireless transmission device), terminal 2 (terminal device), position management server 3 (server device), application server 4, and base station 5. Base station 5 is a base station of moving object communication (cellular communication) or an access point of a wireless LAN such as WiFi (registered trademark).

Transmitter 1 is installed in a facility. The facility is an underground shopping center or a building, and a plurality of transmitters 1 are installed in the facility. Transmitter 1 transmits a wireless signal (beacon signal) to the terminal 2 in a broadcast manner. The wireless signal uses, for example, a 2.4 GHz band based on a BLE (Bluetooth (registered trademark) Low Energy) standard.

Terminal 2 is a smartphone or a tablet terminal owned by a user, and communicates with position management server 3 and application server 4 via base station 5 and the Internet. Terminal 2 receives a wireless signal transmitted from transmitter 1, measures an electric wave strength of the wireless signal, and transmits electric wave information including the electric wave strength and identification information (transmitter ID) of transmitter 1 which is a transmission source to position management server 3.

Position management server 3 holds position electric wave information on electric wave strength of the wireless signal for each transmitter 1 at each position in the facility, determines a position of terminal 2 based on the position electric wave information and the electric wave information acquired from terminal 2, and transmits the position information of terminal 2 to terminal 2.

Application server 4 acquires the position information from terminal 2 and transmits additional information corresponding to the position of terminal 2, for example, map information or the like around terminal 2 to terminal 2.

The position measurement system is effective for the position measurement at a place where a satellite signal hardly reaches like an underground shopping center and a building, but the position measurement system may be applied to a place where an outdoor satellite signal hardly reaches. Even at the place where the satellite signal reaches, if the position measurement performed by the position measurement system and the position measurement performed by the satellite signal are used together, accuracy of the position measurement can be improved.

The position measurement system may acquire absolute position information (latitude and longitude) in the same manner as a general positioning system, but the position measurement system may determine whether or not terminal 2 is located at a specific area, for example, may identify a position in which terminal 2 is located in the store.

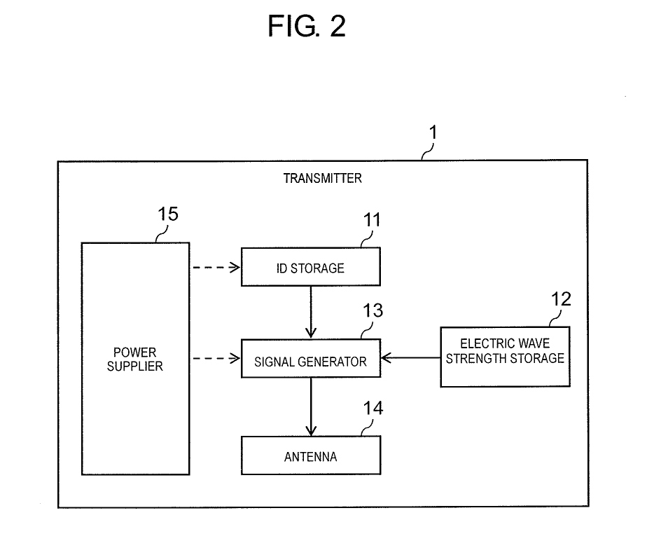

Next, transmitter 1 will be described. FIG. 2 is a block diagram illustrating a schematic configuration of transmitter 1.

Transmitter 1 includes ID storage 11, electric wave strength storage 12, signal generator 13, antenna 14, and power supplier 15.

ID storage 11 stores a transmitter ID for identifying transmitter 1. Electric wave strength storage 12 stores an electric wave strength of a wireless signal transmitted from antenna 14.

Signal generator 13 transmits power for the wireless signal to antenna 14 in order to transmit the wireless signal including the transmitter ID stored in ID storage 11 from antenna 14. At this time, signal generator 13 transmits the power for the wireless signal adjusted according to the electric wave strength stored in electric wave strength storage 12 to antenna 14. Antenna 14 transmits the wireless signal using the transmitted power for the wireless signal.

Power supplier 15 supplies power to each configuration element of transmitter 1. The power supplier is configured with a primary battery. A configuration in which a power generation device such as photovoltaic power generation and a secondary battery are combined may be adopted. If an independent power supply is used in this way, a power supply wiring work is not required, and thereby, transmitter 1 is easily installed, and it is possible to install many transmitters 1 at a low cost.

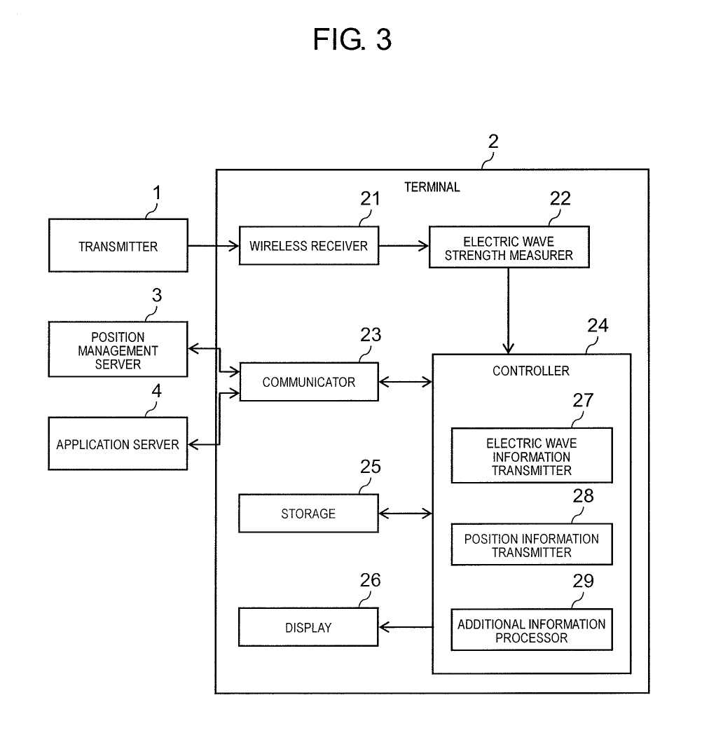

Next, terminal 2 will be described. FIG. 3 is a block diagram illustrating a schematic configuration of terminal 2.

Terminal 2 includes wireless receiver 21, electric wave strength measurer 22, communicator 23, controller 24, storage 25, and displayer 26.

Wireless receiver 21 receives a wireless signal (beacon signal) transmitted from transmitter 1.

Electric wave strength measurer 22 measures the electric wave strength when wireless receiver 21 receives the wireless signal transmitted from transmitter 1.

The communicator 23 communicates with position management server 3. Communicator 23 communicates with application server 4. In the present exemplary embodiment, the electric wave information is transmitted to position management server 3. The position information transmitted from position management server 3 is received.

Storage 25 stores a program to be executed by controller 24.

Controller 24 includes electric wave information transmitter 27, position information transmitter 28, and additional information processor 29. Each unit of controller 24 is realized by causing a processor configuring controller 24 to execute the program stored in storage 25.

If the wireless receiver 21 receives the wireless signal, the electric wave information transmitter 27 acquires the transmitter ID included in the wireless signal, acquires an electric wave strength of the wireless signal from the electric wave strength measurer 22, and performs processing of transmitting the electric wave information including the transmitter ID and the electric wave strength to position management server 3. At this time, by simultaneously receiving the wireless signals transmitted from a plurality of transmitters 1, the electric wave information includes an electric wave strength for each of a plurality of transmitter IDs.

If the position information transmitted from position management server 3 is received by communicator 23, position information transmitter 28 performs processing of transmitting the position information to application server 4. If additional information transmitted from application server 4 is received by communicator 23, additional information processor 29 performs a control to display the additional information together with the position information of terminal 2 on displayer 26.

The display 26 displays the additional information acquired from application server 4 together with the position information of terminal 2 acquired from position management server 3. For example, as additional information, map information around the terminal 2 is acquired from application server 4, and based on the map information and the position information of terminal 2, a screen indicating a current position of terminal 2 is displayed on the map around terminal 2. Thereby, it is possible to present a current position of a user to the user in an easy-to-understand manner.

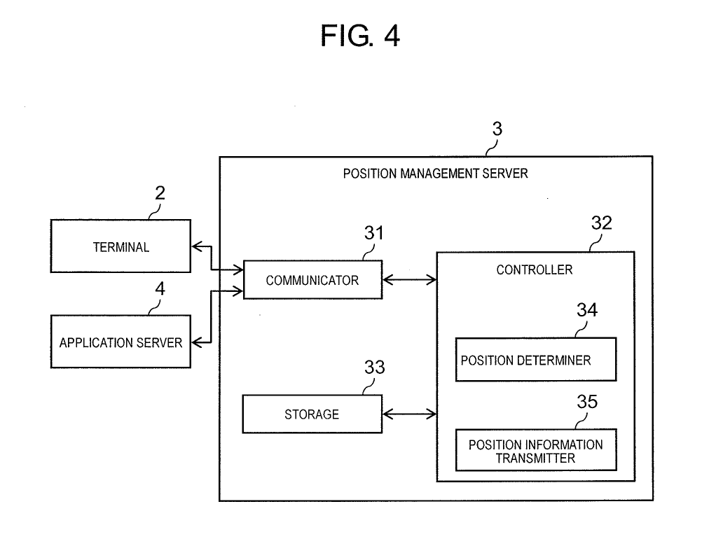

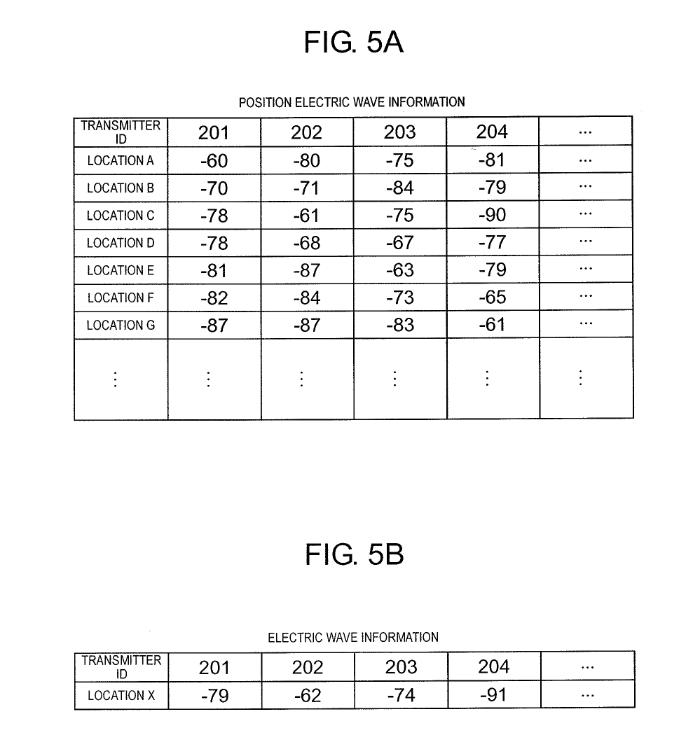

Next, position management server 3 will be described. FIG. 4 is a block diagram illustrating a schematic configuration of position management server 3. FIG. 5A is an explanatory diagram illustrating the position electric wave information. FIG. 5B is an explanatory diagram illustrating the electric wave information.

As illustrated in FIG. 4, position management server 3 includes communicator 31, controller 32, and storage 33.

Communicator 31 communicates with terminal 2. Communicator 31 communicates with application server 4. In the present exemplary embodiment, the electric wave information transmitted from terminal 2 is received. The position information of terminal 2 acquired by controller 32 is transmitted to terminal 2.

Storage 33 stores a program to be executed by controller 32. Storage 33 stores the position electric wave information (see FIG. 5A). The position electric wave information represents an electric wave strength of a wireless signal for each transmitter at each point. The position electric wave information is generated by measuring the electric wave strength of the wireless signal for each transmitter at each point using terminal 2 or a measurement dedicated machine (not illustrated).

Controller 32 includes position determiner 34 and position information transmitter 35. Each unit of controller 32 is realized by causing a processor configuring controller 32 to execute a program stored in storage 33.

Position determiner 34 determines a position of terminal 2 to acquire the position information of terminal 2, based on the electric wave information (see FIG. 5B) transmitted from terminal 2 and received by communicator 31 and the position electric wave information (see FIG. 5A) stored in storage 33. Position information transmitter 35 transmits the position information of terminal 2 acquired by position determiner 34 to terminal 2.

Here, position determiner 34 compares the electric wave strength of each transmitter 1 included in the electric wave information acquired from terminal 2 with the electric wave strength of each transmitter 1 at each position included in the position electric wave information, and determines a position of terminal 2 from a location of the position electric wave information, based on similarity of the electric wave strength for each transmitter 1. Specifically, for each location of the position electric wave information, a difference (absolute value) between an electric wave strength of the position electric wave information and an electric wave strength of the electric wave information is calculated for each transmitter 1, and the differences for respective transmitters 1 are summed. Total values of the differences at the respective locations are compared with each other, and the location where the total values of the differences become the smallest is determined as position of terminal 2.

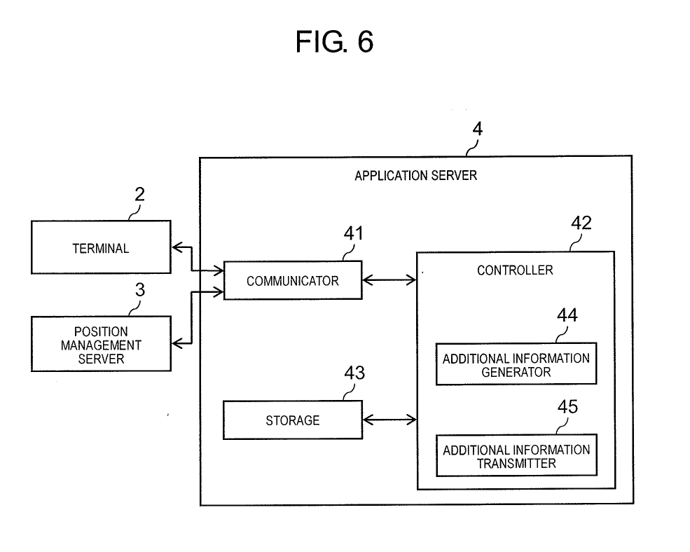

Next, application server 4 will be described. FIG. 6 is a block diagram illustrating a schematic configuration of application server 4.

Application server 4 includes communicator 41, controller 42, and storage 43.

Communicator 41 communicates with terminal 2. Communicator 41 communicates with position management server 3. In the present exemplary embodiment, position information of the terminal transmitted from terminal 2 is received. The additional information generated by controller 42 is transmitted to terminal 2.

Storage 43 stores a program to be executed by controller 42.

Controller 42 includes additional information generator 44 and additional information transmitter 45. Each unit of controller 42 is realized by causing a processor configuring controller 42 to execute a program stored in storage 43.

If the position information of terminal 2 transmitted from terminal 2 is received by communicator 41, additional information generator 44 generates additional information such as map information around terminal 2 based on the position information of terminal 2. Additional information transmitter 45 transmits the additional information generated by additional information generator 44 to terminal 2.

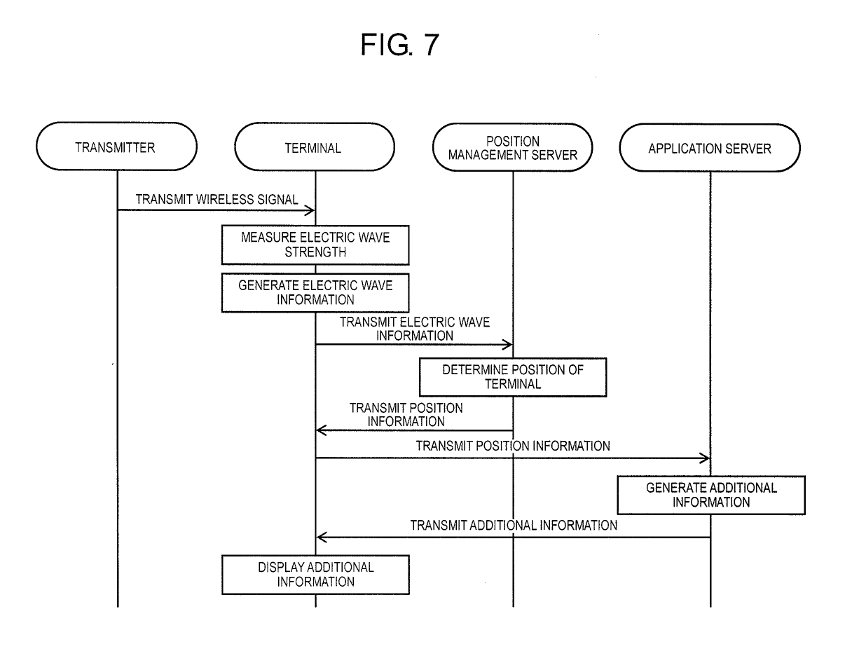

Next, an operation sequence of transmitter 1, terminal 2, position management server 3, and application server 4 will be described. FIG. 7 is a sequence diagram illustrating an operation sequence of transmitter 1, terminal 2, position management server 3, and application server 4.

First, transmitter 1 transmits a wireless signal (beacon signal) to terminal 2.

In terminal 2, if wireless receiver 21 receives the wireless signal transmitted from transmitter 1, the electric wave strength measurer 22 measures an electric wave strength of the received wireless signal. Next, the electric wave information transmitter 27 acquires the transmitter ID from the received wireless signal, generates electric wave information including the transmitter ID and the electric wave strength, and transmits the electric wave information to position management server 3.

In position management server 3, if communicator 31 receives the electric wave information transmitted from terminal 2, position determiner 34 determines the position of terminal 2 to acquire the position information of terminal 2, based on the electric wave information acquired from terminal 2 and position electric wave information stored in storage 33. Position information transmitter 35 transmits the position information of terminal 2 to terminal 2.

In terminal 2, if communicator 23 receives the position information transmitted from position management server 3, position information transmitter 28 transmits the position information acquired from position management server 3 to application server 4.

In application server 4, if communicator 41 receives the position information transmitted from terminal 2, additional information generator 44 generates additional information on the map around terminal 2, based on the position information acquired from terminal 2. Additional information transmitter 45 transmits the additional information to terminal 2.

In terminal 2, if communicator 23 receives the additional information transmitted from application server 4, additional information processor 29 displays the additional information acquired from application server 4 on the display 26 together with the position information of terminal 2 acquired from position management server 3. Thereby, a screen showing a current position of terminal 2 on the map around terminal 2 is displayed on displayer 26.

In the present exemplary embodiment, application server 4 acquires the position information of terminal 2 from terminal 2, but application server 4 may directly acquire the position information from position management server 3 that determines the position of terminal 2.

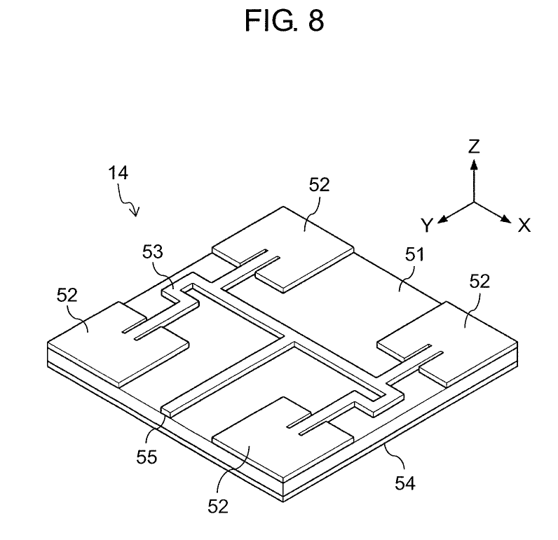

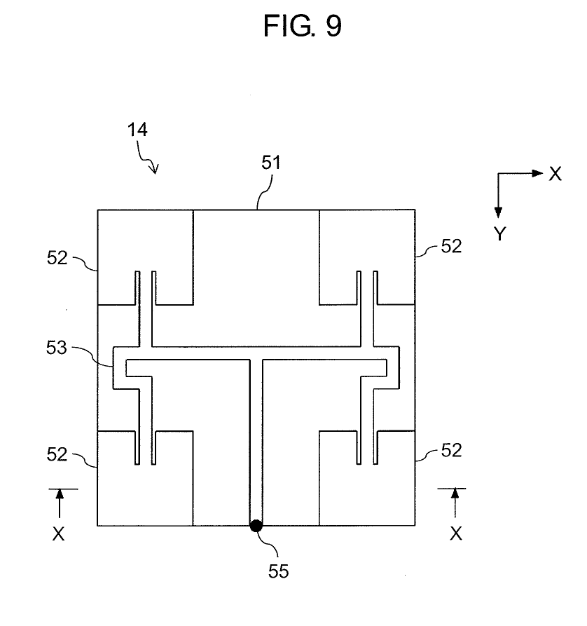

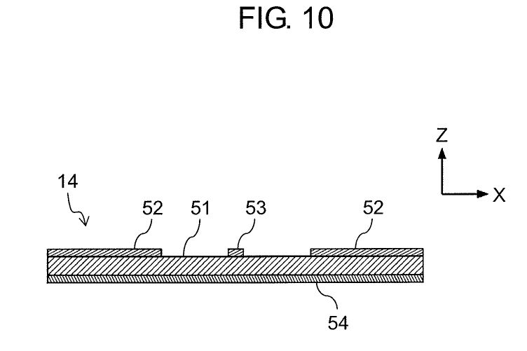

Next, antenna 14 of transmitter 1 will be described. FIG. 8 is a perspective view of antenna 14. FIG. 9 is a front view of antenna 14. FIG. 10 is a cross-sectional view of antenna 14 taken along line X-X illustrated in FIG. 9.

As illustrated in FIG. 8, antenna 14 includes board 51, four patches 52 (radiation conductors), power supply line 53 (power supply conductor), and ground 54 (ground conductor).

As illustrated in FIG. 9, board 51 has a rectangular flat plate shape and is formed of a dielectric material. Patch 52 has a rectangular shape, is formed of a conductor such as a copper foil, and is formed on an output surface (first surface) of board 51. In the same manner as in patch 52, power supply line 53 is formed of a conductor such as a copper foil and is formed on the output surface of board 51. Power supply line 53 leads the power supplied to power supply point 55 to patch 52, and a wireless electric wave is radiated from patch 52 by the power supplied from power supply point 55 via power supply line 53. Power supply line 53 is formed inside a region where patch 52 is disposed.

As illustrated in FIG. 10, ground 54 is formed on the whole back surface (second surface) of board 51 opposite to an output surface provided with patch 52. Ground 54 reflects the electric wave radiated from patch 52 in the −Z direction, and since the electric wave reflected by ground 54 moves in the +Z direction, a gain of the electric wave in the +Z direction can be increased, and directivity in the +Z direction can be enhanced.

As illustrated in FIG. 8, four patches 52 are arranged in a 2×2 array, that is, in a matrix shape in which two patches are arranged in the X direction and two patches are arranged in the Y direction.

Four signals, each having a phase-converted by half wavelength or by quarter wavelength, are individually input to four patches 52. Thereby, four electric waves radiated from four patches 52 increase in gain as electric wave components traveling in the air in the +Z direction resonate with each other. Meanwhile, electric wave components traveling in the air in a direction inclined from the +Z direction decrease in gain by cancelling each other out. As a result, a high gain is obtained in the +Z direction, and an electric waveform with directionality in the +Z direction can be obtained.

Patches 52 are arranged at four corners of board 51, and board 51 and ground 54 are formed so as not to protrude outside four patches 52.

In the present exemplary embodiment, power supply line 53 is provided on an output surface on which the patch 52 is disposed in board 51, but a through hole into which a line for power supply is inserted may be provided in board 51, and power is supplied from a rear side of board 51 to patch 52.

In the present exemplary embodiment, patch 52 is formed in a square shape, but patch 52 may be formed in a circle shape.

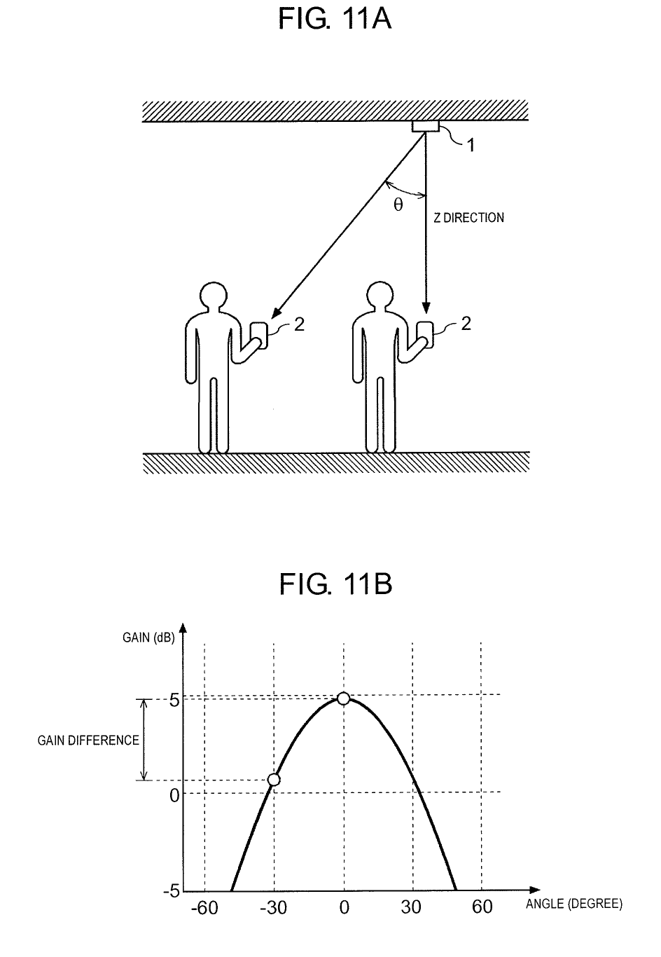

Next, a gain difference required for antenna 14 will be described. FIG. 11A is an explanatory diagram illustrating an example of an installation state of transmitter 1. FIG. 11B is a graph illustrating a relationship between an angle and a gain with respect to the Z direction.

In the example illustrated in FIG. 11A, transmitter 1 is installed on the ceiling of a building. In addition to being installed on a front side of the ceiling, transmitter 1 may be installed on a rear side of the ceiling. Antenna 14 is disposed with an output surface provided with the patch 52 facing downward (see FIG. 8).

In the present exemplary embodiment, the position of terminal 2 is identified based on the electric wave strength when terminal 2 receives a wireless signal (beacon signal) transmitted from transmitter 1. At this time, a necessary accuracy is required for position identification. For example, in processing of analyzing a movement line of a person in a factory or the like, and navigation in a public facility such as an airport, position identification with an accuracy of 2 m is required.

In order to achieve the accuracy of position identification, as illustrated in FIG. 11A, a significant difference needs to appear between the electric wave strength at a position just below transmitter 1 and the electric wave strength at a position laterally deviated by a distance corresponding to the required accuracy from the position. If this is described by using antenna feature, the significant difference needs to appear between a gain in the direction just below transmitter 1, that is, a gain in the Z direction and a gain in a direction tilted by angle θ corresponding to the required accuracy with respect to the Z direction.

Here, there is electric wave noise of approximately 3 to 4 dB in any environment, and in order to be able to identify the position with a required accuracy in an environment where the electric wave noise exists, it is necessary that a gain difference which is a difference between the gain in the Z direction and the gain in the direction tilted by angle θ with respect to the Z direction is a value (for example, 4 to 5 dB or more) exceeding a level of the electric wave noise.

In the example illustrated in FIG. 11B, angle θ with respect to the Z direction is set to 30 degrees, and a gain difference of 4.5 dB can be ensured at the angle of 30 degrees. Since the gain difference exceeds a level of ordinary electric wave noises (approximately 3 to 4 dB), it is possible to perform position identification with a high accuracy.

An angle of terminal 2 viewed from transmitter 1 changes depending on a height of the ceiling. Accordingly, an installation interval of transmitter 1 may be adjusted according to the height of the ceiling. For example, in a case where the ceiling is higher than a standard height (for example, 3 m), the installation interval of transmitter 1 may be shortened.

In this way, in antenna 14, in order to realize the accuracy required for the position identification, it is necessary to ensure a gain difference between two reference angles. The gain difference can be adjusted by a distance between the patches, that is, a distance between the centers of two patches 52 arranged in the X direction and the Y direction. That is, if the distance between the patches is reduced, the gain difference is reduced, and if the distance between the patches is increased, the gain difference can be increased.

Here, the main purpose of antenna 14 according to the present exemplary embodiment is to reduce the size of antenna 14, and in order to miniaturize antenna 14, first, it is effective to reduce the distance between the patches. However, if the distance between the patches is reduced, the gain difference is reduced, and the accuracy of position identification is reduced.

Therefore, in the present exemplary embodiment, in order to miniaturize antenna 14, the distance between the patches is set so as to ensure a minimum gain difference allowable for realizing the accuracy required for position identification.

Meanwhile, if ground 54 is formed widely, leaking electric waves are reduced and an absolute gain is increased, and thus, a communication performance can be improved. Accordingly, in general, board 51 and ground 54 are formed so as to largely protrude to the outside of patch 52. However, antenna 14 according to the present exemplary embodiment is used for a position identification purpose, and a high communication performance is not required.

Therefore, in the present exemplary embodiment, board 51 and ground 54 are formed so as not to protrude to the outside of the patch 52. Thereby, it is possible to ensure the accuracy of the required position measurement and to miniaturize the antenna. Meanwhile, narrowing ground 54 reduces the absolute gain, but there is no practical problem in use of the position identification.

### Second Exemplary Embodiment

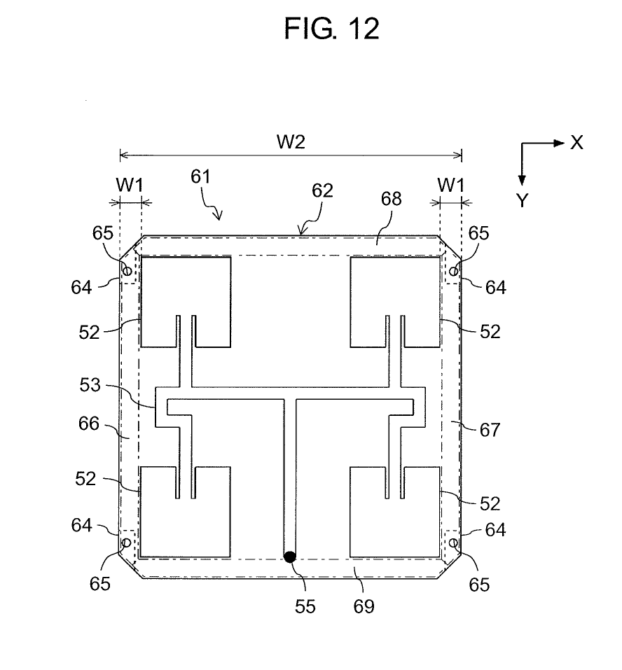

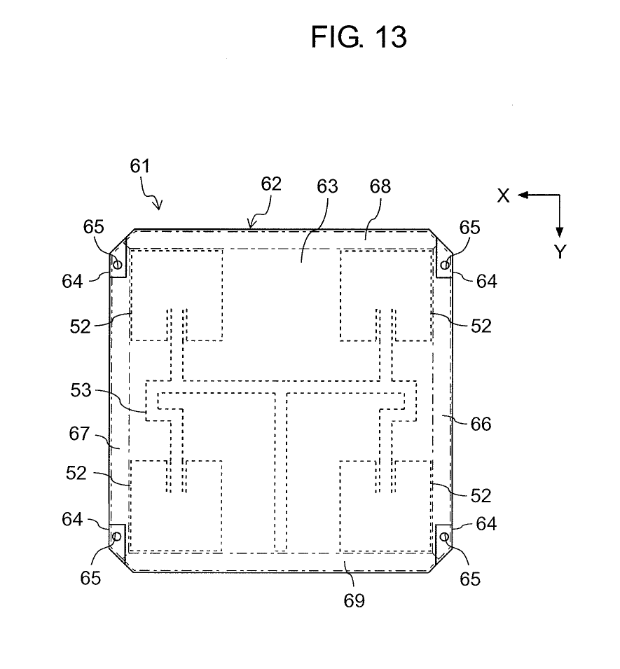

Next, a second exemplary embodiment will be described. FIG. 12 is a front view of antenna 61 according to the second exemplary embodiment. FIG. 13 is a rear view of antenna 61 according to the second exemplary embodiment. Here the same points as in the above-described exemplary embodiment are not described in particular.

As illustrated in FIGS. 12 and 13, antenna 61 according to the second exemplary embodiment includes board 62, four patches 52, power supply line 53, and ground 63, in the same as antenna 14 according to the first exemplary embodiment, but particularly, in the present exemplary embodiment, attachment portion 64 is formed outside four patches 52 on board 62.

A screw (fixing component) for being fixed to a case of transmitter 1 is attached to attachment portion 64, and screw hole 65 into which the screw is inserted is formed in attachment portion 64.

Board 62 includes first and second peripheral edge portions 66 and 67 (regions surrounded by an alternated long and short dash line in FIG. 12) including attachment portions 64 on the outside of patches 52, and attachment portions 64 are located at both ends of first and second peripheral edge portions 66 and 67. First and second peripheral edge portions 66 and 67 are located outside the X direction with respect to patches 52. Board 62 further includes third and fourth peripheral edge portions 68 and 69 (regions surrounded by an alternated long and short dash line in FIG. 12) located outside in the Y direction with respect to patches 52.

Here, width W1 of first and second peripheral edge portions 66 and 67 may be one eighth of width W2 of board 62. Thereby, it is possible to ensure a sufficient size of attachment portion 64, and to stably support board 62 to the case of transmitter 1. If attachment portion 64 can be ensured, width W1 of peripheral edge portions 66 and 67 may be narrowed more than one eighth of entire width W2 of board 62. Thereby, it is possible to reduce a size of antenna 61.

In the example illustrated in FIG. 12, attachment portions 64 are provided on first and second peripheral edge portions 66 and 67, but attachment portions 64 may be provided on third and fourth peripheral edge portions 68 and 69. For example, one attachment portion 64 may be provided in first and second peripheral edge portions 66 and 67, and two attachment portions 64 may be provided on either one of third and fourth peripheral edge portions 68 and 69. In this way, in a case where attachment portions 64 are provided on third and fourth peripheral edge portions 68 and 69, a relationship between width W1 and width W2 with respect to first and second peripheral edge portions 66 and 67 may also be applied to third and fourth peripheral edge portions 68 and 69. At this time, width W2 may be replaced with a width of board 62 in the Y direction.

As illustrated in FIG. 13, ground 63 is formed in a region on a rear surface corresponding to a region where patch 52 is disposed and a region except for attachment portion 64 in peripheral edge portions 66 to 69. Thereby, since an absolute gain is increased as ground 63 is widened, it is possible to improve a communication performance.

In the present exemplary embodiment, a screw is used as a fixing component for fixing antenna 61 to the case of transmitter 1, but the fixing component is not limited to the screw. For example, a pin, a boss, a spacer, and the like may be provided so as to protrude from board 62.

Electronic components configuring ID storage 11, electric wave strength storage 12, and signal generator 13 (see FIG. 2), a battery configuring power supplier 15 (see FIG. 2) and a battery holder may be mounted on board 62. In this case, the battery holder may be disposed on a rear side of board 62. The electronic components may be arranged on an output surface of board 62 and may be connected to power supply line 53. At this time, in order to suppress an influence on electric waves radiated from patches 52, the electronic components may be arranged outside the region where patches 52 on the output surface are arranged.

As described above, exemplary embodiments are described as an example of the technique disclosed in the present application. However, the technology according to the present disclosure is not limited to this, and can also be applied to exemplary embodiments in which a change, replacement, addition, omission, and the like are performed. It is also possible to combine the respective components described in the above exemplary embodiments to provide a new exemplary embodiment.

For example, in the above-described exemplary embodiments, the electric wave information is provided from the terminal to the position management server, and the position management server determines the position of the terminal, based on the electric wave information acquired from the terminal and the position electric wave information held by the position management server, but it is also possible to provide the position electric wave information to the terminal from the position management server and the terminal may determine the position of the terminal itself based on the electric wave information acquired by the terminal itself and the position electric wave information acquired from the position management server.

### INDUSTRIAL APPLICABILITY

An antenna, a wireless transmission device, and a position measurement system according to the present disclosure have effects of ensuring an accuracy of a required position measurement and miniaturizing the antenna, and are useful as an antenna that transmits a wireless signal for position measurement, a wireless transmission device including the antenna, a position measurement system, and the like.

### REFERENCE MARKS IN THE DRAWINGS

1 TRANSMITTER (WIRELESS TRANSMISSION DEVICE)
2 TERMINAL (TERMINAL DEVICE)
3 POSITION MANAGEMENT SERVER (SERVER DEVICE)
11 ID STORAGE
13 SIGNAL GENERATOR
14 ANTENNA
51 BOARD
52 PATCH (RADIATION CONDUCTOR)
53 POWER SUPPLY LINE (POWER SUPPLY CONDUCTOR)
54 GROUND (GROUND CONDUCTOR)
55 POWER SUPPLY POINT
61 ANTENNA
62 BOARD
63 GROUND (GROUND CONDUCTOR)
64 ATTACHMENT PORTION
65 SCREW HOLE
66 to 69 PERIPHERAL EDGE PORTION

1. An antenna which transmits a wireless signal for position measurement, comprising:
a board that is formed of a dielectric material;
four radiation conductors that are formed in a 2×2 array on a first surface of the board; and
a ground conductor that is formed on a second surface of the board,
wherein the board and the ground conductor are formed so as not to protrude to an outside of the four radiation conductors.

2. An antenna which transmits a wireless signal for position measurement, comprising:
a board that is formed of a dielectric material;
four radiation conductors that are formed in a 2×2 array on a first surface of the board; and
a ground conductor that is formed on a second surface of the board,
wherein an attachment portion to which a fixing component for being fixed to a case is attached is formed on an outside of the four radiation conductors on the board.

3. The antenna of claim 2,
wherein the board includes a peripheral edge portion including the attachment portion on the outside of the radiation conductor, and
wherein the ground conductor is formed in a region of the second surface corresponding to a region where the radiation conductor is formed and a region other than the attachment portion in the peripheral edge portion.

4. The antenna of claim 3,
wherein the peripheral edge portion has a width smaller than or equal to one eighth of an entire width of the board.

5. The antenna of claim 1, further comprising:
a power supply conductor that is formed on the first surface and supplies power to the radiation conductor,
wherein the power supply conductor is formed on an inside of a region where the radiation conductor is formed.

6. A wireless transmission device comprising:
the antenna according to claim 1;
a storage that stores identification information of the wireless transmission device; and
a signal generator that outputs power for a wireless signal to the antenna for transmitting the wireless signal including the identification information of the wireless transmission device from the antenna.

7. A position measurement system comprising:
the wireless transmission device of claim 6;
a terminal device that receives the wireless signal which is transmitted from the wireless transmission device; and
a server device,
wherein the terminal device acquires an electric wave strength when receiving the wireless signal and transmits the electric wave strength to the server device, and
wherein the server device acquires position information of the terminal device based on the electric wave strength acquired from the terminal device and transmits the position information to the terminal device.
